(19) United States
(12) Patent Application Publication
(10) Pub. No.: US 2024/0165433 A1
(43) Pub. Date: May 23, 2024

(54) Passive Moisture Trapping Apparatus

(71) Applicant: United States of America, as represented by the Secretary of the Navy, Patuxent River, MD (US)

(72) Inventors: Gustavus Alston Rush, Leonardtown, MD (US); Adam Gohl, Detroit, MI (US); Joseph Melotik, Huron Township, MI (US); Richard Coughlan, III, Great Mills, MD (US); Christian Gotsch, Hollywood, MD (US)

(21) Appl. No.: 17/989,052

(22) Filed: Nov. 17, 2022

(51) Int. Cl. A62B 9/00; A62B 7/14

(52) U.S. Cl. CPC A62B 9/003; A62B 7/14

(57) ABSTRACT

A passive moisture trapping apparatus for use with an oxygen system, the oxygen system includes an exhalation sensor system and an exhalation hose, the apparatus comprising a shaped tube having a trap portion, a first end, and a second end, the first end attached to the exhalation sensor system, the second end attached to the exhalation hose, the trap portion having horizontal beams running across the trap portion such that a passive moisture trapping material can be inserted and removed from the trap portion.

### STATEMENT OF GOVERNMENT INTEREST

The invention described herein may be manufactured and used by or for the Government of the United States of America for governmental purposes without payment of any royalties thereon or therefor.

### BACKGROUND

VigilOx is a sensor suite that monitors pilots' inhalation and exhalation throughout a flight. VigilOx monitors the air flow entering and leaving the pilot's body, assessing it for changes in pressure, humidity, temperature, oxygen concentration, flow rate, and carbon dioxide content. The VigilOx system consists of two sensor modules that can be interfaced to a host computer or operate autonomously.

An Inhalation Sensor Block (ISB) is a sensor system responsible for pilot respiration inhalation gas supply data collection and is intended to be located directly in series with the pilot's dry gas supply and post regulator. It primarily operates as an autonomous standalone battery operated device storing sensor data on a micro SD Card (data storage). It can also be used to provide low data rate query response to a host computer. The ISB hardware configuration also includes a power switch, an on-board real time clock with back-up battery, a micro SD Card socket, and a “local” primary battery (9V).

The Exhalation Sensor Block (ESB) is a sensor system responsible for collecting data from pilot respiration exhalation. This device/system is mask mounted via an exhalation tube and mask pressure tap assembly. As with the ISB, the ESB primarily operates as an autonomous standalone battery operated device with a real-time clock and micro SD Card (data storage), however, it can also be used to provide low data rate query response to a host computer.

Often the ESB and other physiological monitors may accumulate moisture within its tubes or various other locations throughout the system. Multiple VigilOx ESB sensor inaccuracies have been attributed to the condensation of the pilot's fully saturated exhalation breath. This condensation has blocked pressure ports for flow measurements and has impeded the optical sensor for Oxygen concentration measurements. Colder wintertime temperatures and different flight conditions could attribute to additional condensation in ESB. Thus, there is a need for a moisture trapping apparatus within such a system.

### SUMMARY

The present invention is directed to with the needs enumerated above and below.

The present invention is directed to a passive moisture trapping apparatus for use with a breathing gas measurement system, the breathing gas measurement system includes an exhalation sensor system and an exhalation hose, the apparatus comprising of a shaped tube having a trap portion, a first end, and a second end, the first end attached to the exhalation sensor system, the second end attached to the exhalation hose, and passive moisture trapping material that can be inserted and removed from the trap portion.

It is a feature of the present invention to provide a passive moisture trapping apparatus for the purpose of reducing the humidity related error in air quality measurement systems. The reduction in humidity is meant to reduce the humidity-related error in air quality and breathing quality measurement systems. These air quality measurement systems quantify the breathing quality and air quality metrics (for example, but without limitation, 02 percentage, mask pressure, breathing rate, flow rate, CO2 percentage).

It is a feature of the present invention to provide a passive moisture trapping apparatus for reducing moisture in tubes in an oxygen system or any other breathing gas system.

It is a feature of the present invention to provide a passive moisture trapping apparatus that reduces moisture in an open-circuit oxygen system or a closed circuit oxygen system.

It is a feature of the present invention to provide a passive moisture trapping apparatus that can be manufactured via additive manufacturing, thus, allowing shapes to be created that typically cannot be created via other manufacturing processes.

It is a feature of the present invention to provide a passive moisture trapping apparatus that can be manufactured via dual-material additive manufacturing, thus, allowing more rigid polymeric material to be structurally supporting while a softer polymeric material would allow attachment, sealing, and retainment of the apparatus to the sensor system.

### DRAWINGS

These and other features, aspects and advantages of the present invention will become better understood with reference to the following description and appended claims, and accompanying drawings wherein:

FIG. 1 is a front view of the passive moisture trapping apparatus as installed on an ESB;

FIG. 2 is a right view of the passive moisture trapping apparatus as installed on an ESB;

FIG. 3 is a top view of the passive moisture trapping apparatus as installed on an ESB;

FIG. 4 is a side Section A-A view of the passive moisture trapping apparatus as installed on an ESB; and,

FIG. 5 is the trap section top view with B-B section of passive moisture trapping apparatus.

### DESCRIPTION

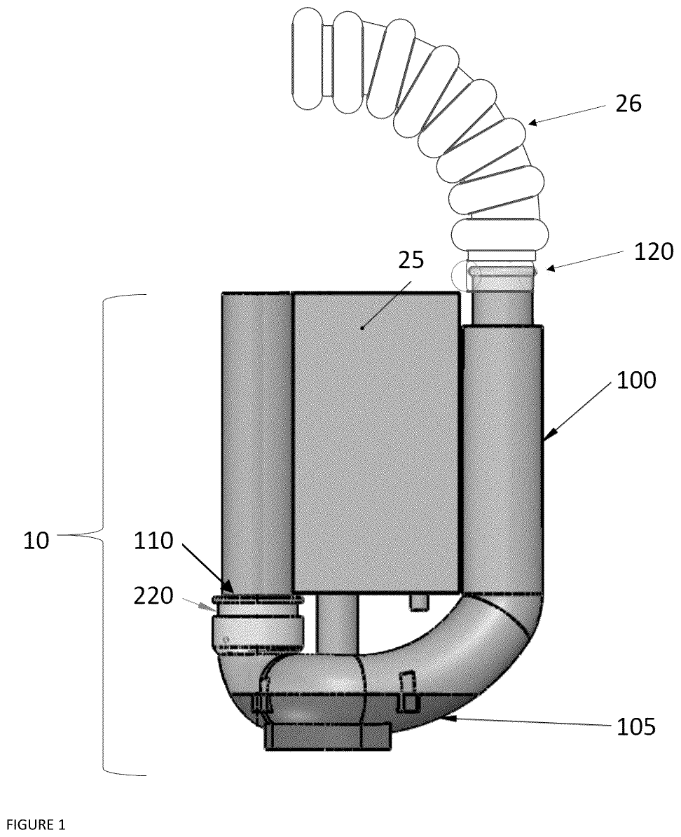

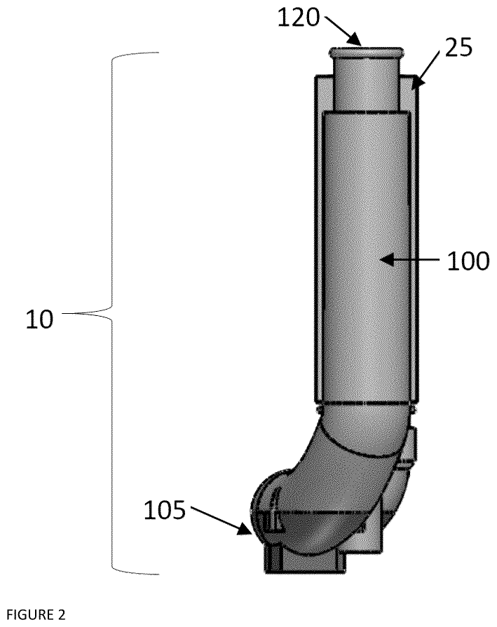

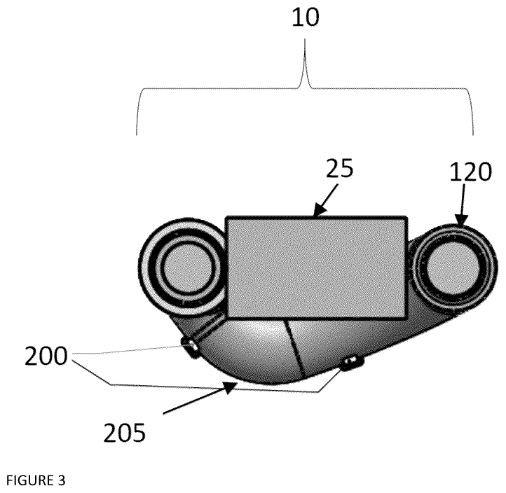

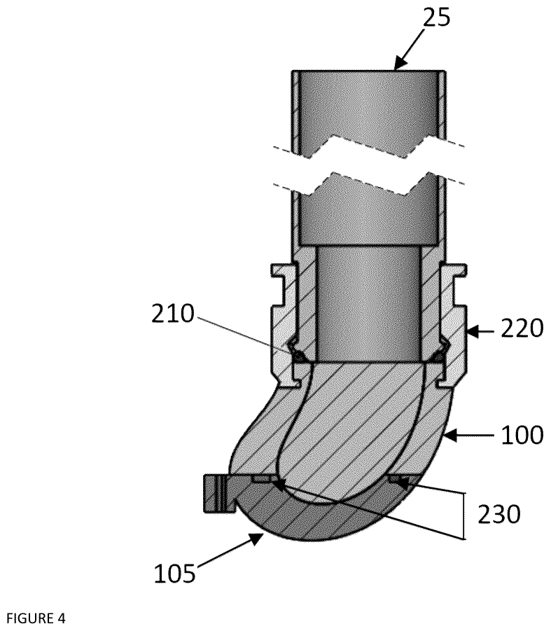

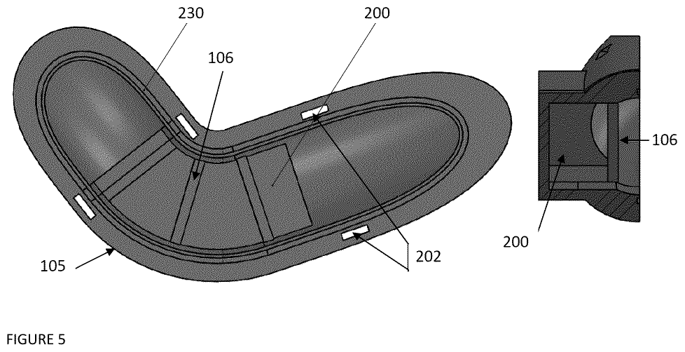

The preferred embodiments of the present invention are illustrated by way of example below and in FIGS. 1-5. The passive moisture trapping apparatus 10 is for use with either an open-circuit or closed-circuit oxygen system (not shown). The oxygen system includes an exhalation sensor block 25 and an exhalation hose 26. The passive moisture trapping apparatus 10 includes a shaped tube, preferably a J-shaped tube 100. However, the tube can be J, U or S shaped, or any shape practicable. The J-shaped tube 100 has a trap portion 105, a first end 110, and a second end 120. The first end 110 is attached to the exhalation sensor block 25 by an elastomeric section 220 and an o-ring 210, while the second end 120 is attached to the exhalation hose 26, the trap portion 105 has horizontal beams 106 running across the trap portion 105 such that a passive moisture trapping material 200 can be inserted and removed from the trap portion 105. The passive moisture trapping apparatus 10 can include a bend 205 in the tube 100 between the first end 110 and the second end 120, which allows the connection of an event marker or a real-time data link to the exhalation sensor block 25. In one of the embodiments of the invention, the passive moisture trapping material 200 can be secured by adhesion, or any other means practicable. The trap portion 105 can be secured to the J-shaped tube 100 assembly by zip-ties (or any other type of attachment mechanism that is practicable) that are retained by embedded slots 202 in the trap portion 105 and the J-shaped tube 100 portion. The trap portion 105 is sealed to the J-shaped tube 100 assembly by a silicone adhesive gasket 230.

The present invention can be manufactured from many processes including, but not limited, via polymeric or metallic additive manufacturing, injection molding, casting, and extrusion. The passive moisture trapping apparatus 10 includes, but without limitation, different cross-sectional geometries that are designed to enable adaptation to various exhalation sensor systems, to include allowing the systems to maintain native electrical connections and trigger devices. For example, one embodiment of the invention may resemble a symmetrical J-shape cross-section while another embodiment may resemble an S-shape, or even a non-symmetrical J-shape to allow for the connection of the event marker trigger in the exhalation sensor system.

In the description of the present invention, the invention will be discussed in a military environment; however, this invention can be utilized for any type of application that requires use of a breathing system.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed is:

1. A passive moisture trapping apparatus for use with an oxygen system, the oxygen system includes an exhalation sensor system and an exhalation hose, the apparatus comprising:
a shaped tube having a trap portion, a first end, and a second end, the first end attached to the exhalation sensor system, the second end attached to the exhalation hose, the trap portion having horizontal beams running across the trap portion such that a passive moisture trapping material can be inserted and removed from the trap portion.

2. The trap portion of claim 1 secures the passive moisture trapping material by adhesion.

3. The apparatus of claim 1, wherein the apparatus further includes an o-ring disposed between the first end and the exhalation sensor block.

4. The apparatus of claim 1, wherein the apparatus is manufactured from a process selected from the group consisting of polymeric additive manufacturing, metallic additive manufacturing, injection molding, casting, and extrusion.

5. The passive moisture trapping apparatus of claim 1 that includes different cross-sectional geometries that are designed to enable adaptation to various exhalation sensor systems, to include allowing the systems to maintain native electrical connections and trigger devices.

6. The apparatus of claim 1, wherein the shaped tube is a shape selected from the group consisting of symmetrical J, U, and S-shaped.
